(19) United States
(12) Patent Application Publication
(10) Pub. No.: US 2019/0299152 A1
(43) Pub. Date: Oct. 3, 2019

(54) DRYING ASSEMBLY WITH SHAPE MEMORY ALLOY ACTUATOR

(71) Applicant: GM Global Technology Operations LLC, Detroit, MI (US)

(72) Inventors: Paul W. Alexander, Ypsilanti, MI (US); Robert Dallos, JR., Holland, MI (US); Mark R. Gordon, Warren, MI (US); Shannen M. Borngesser, Macomb Township, MI (US)

(73) Assignee: GM Global Technology Operations LLC, Detroit, MI (US)

(21) Appl. No.: 15/937,144

(22) Filed: Mar. 27, 2018

(51) Int. Cl. B01D 53/04; F16K 31/02; B01D 53/26; F21S 45/50; F21S 45/60

(52) U.S. Cl. CPC B01D 53/0438; F16K 31/025; B01D 53/261; F21S 45/50; B01D 2259/4566; B01D 2253/112; B01D 2257/80; B01D 2259/40098; F21S 45/60

(57) ABSTRACT

A drying system includes an assembly with a housing defining an interior space. The housing has an inner wall with a first opening through which the inner chamber communicates with the outer chamber. The housing has an outer wall with a second opening. A rechargeable desiccant and a door are disposed in the outer chamber, and the door is movable between a first position and a second position. The door at least partially seals the second opening and unseals the first opening when in the first position, and at least partially seals the first opening and unseals the second opening when in the second position. A shape memory alloy actuator moves the door between the first position and the second position in response to a change in temperature of the shape memory alloy.

### INTRODUCTION

The present disclosure generally relates to a drying system for an interior space of a housing, such as for a lamp assembly.

Lenses of lamp assemblies, such as vehicle headlamp assemblies, may become fogged due to an accumulation of moisture within the assembly. Desiccants are sometimes used to absorb moisture in lamp assemblies. Desiccants reach a maximum capacity at which they are unable to further absorb moisture.

Rechargeable desiccants, sometimes referred to as regenerating desiccants or reusable desiccants, may be “recharged”, also referred to as “regenerated”, by heating the desiccant to release the absorbed moisture. The rechargeable desiccant then has capacity to continue absorbing moisture.

### SUMMARY

Configuring a drying system with a rechargeable desiccant is challenging in many applications due to space constraints. Minimizing power consumption and added weight are also considerations, especially in vehicle applications. Drying systems disclosed herein include a shape memory alloy actuator to control venting of an interior space of the assembly. A shape memory alloy actuator provides a low weight, and relatively low power consumption solution. In some embodiments, power consumption is minimized by integrating heating of the shape memory alloy actuator and the desiccant.

A drying system comprises an assembly that includes a housing defining an interior space. For example, the assembly may be a lamp assembly, such as for a vehicle lamp assembly having a lens mounted to the housing at the interior space. In other examples, the assembly may be a sensor assembly having an emitting or receiving component at the interior space for which moisture could affect performance or aesthetics.

The housing has an inner wall that divides the interior space into the inner chamber and the outer chamber. The inner wall has a first opening through which the inner chamber communicates with the outer chamber. The housing has an outer wall with the outer chamber between the inner wall and the outer wall, and with a second opening in the outer wall. A rechargeable desiccant is disposed in the outer chamber. A door is disposed in the outer chamber and is configured to be movable between a first position and a second position. The door is configured to at least partially seal the second opening and unseal the first opening when in the first position, and at least partially seal the first opening and unseal the second opening when in the second position. An actuator is operatively connected to the door and is configured to move the door between the first position and the second position. The actuator is formed from a shape memory alloy transitionable between a first state and a second state in response to a change in temperature of the shape memory alloy. In some cases, the change in temperature is due to electrical energizing of the actuator. The shape memory alloy transitions between the first state and the second state to move the door from the first position to the second position.

Accordingly, when the door is in the first position, the exterior environment is blocked from both chambers, and the desiccant removes humidity from both chambers. When the door is in the second position, the inner chamber is sealed, protecting the inner chamber from moisture, while the outer chamber is in communication with the exterior environment, allowing moisture released from the desiccant during regeneration of the desiccant to be expelled from the outer chamber to the exterior environment. In one or more embodiments, a biasing spring biases the door to the first position. Accordingly, the first position is maintained in the absence of any electrical power. In some of these embodiments, power remains on to the actuator, or at least intermittently on, to keep the door from returning to the first position during recharging of the desiccant.

In one or more embodiments, the actuator is configured as a wire that contracts in length in response to the change in temperature. For example, a first end of the actuator may be anchored to the housing and a second end of the actuator may be anchored to the door. The door may be pivotably secured to the housing and pivot about a pivot axis when the door moves from the first position to the second position. Such pivoting motion may be referred to as articulation.

In one or more embodiments, heating of the shape memory alloy actuator and the desiccant is integrated. For example, electrical power may be provided to the shape memory alloy to increase the temperature of the shape memory alloy to a predetermined temperature at or above which the shape memory alloy transitions from the first state to the second state. The rechargeable desiccant may be disposed in sufficient proximity to the actuator such that heat from the actuator heats the rechargeable desiccant to remove moisture absorbed by the rechargeable desiccant. Stated differently, heat that radiates from the heated actuator heats the rechargeable desiccant. No separate heating element for the desiccant is used, and, accordingly, no separate electric power circuit for heating the rechargeable desiccant is needed. Instead, a power source may be selectively connectable to the actuator to electrically energize the actuator, thereby heating the shape memory alloy such that the shape memory alloy transitions from the first state to the second state. An electronic controller is operable to selectively connect the power source to the actuator, such as when desiccant recharging is to be performed.

Alternatively, in one or more other embodiments where heating of the shape memory alloy actuator and the desiccant is integrated, a heating element is disposed in the outer chamber and is electrically energizable to heat the rechargeable desiccant sufficiently to remove moisture absorbed by the rechargeable desiccant. The actuator is disposed in sufficient proximity to the heating element such that the shape memory alloy is transitionable from the first state to the second state in response to heat from the heating element. Stated differently, heat that radiates from the heating element to heat the rechargeable desiccant also causes a temperature change in the shape memory alloy to cause the transition to the second state, and the resulting movement of the door to the second position. No separate electric power circuit for heating the shape memory alloy is needed. Instead, a power source is selectively connectable to the heating element to electrically energize the heating element, and an electronic controller is operable to selectively connect the power source to the heating element.

In one or more embodiments, the rechargeable desiccant and the shape memory alloy are separately electrically energized. For example, the drying system may include a heating element disposed in the outer chamber and electrically energizable to heat the rechargeable desiccant sufficiently to remove moisture absorbed by the rechargeable desiccant. A power source may be selectively connectable to the actuator to electrically energize the actuator, thereby heating the shape memory alloy such that the shape memory alloy transitions from the first state to the second state, so that the door is in the second position when the heating element is energized. The power source may be selectively connectable to the heating element separately from the actuator to electrically energize the heating element. An electronic controller may be operable to selectively connect the power source to the actuator, and to separately selectively connect the power source to the heating element.

In other embodiments, the drying system is configured so that the power need not remain on to the actuator in order to keep the door in the first position. For example, a bi-stable spring and antagonistic shape memory actuators may be used. In one or more embodiments the actuator is a first actuator, and the assembly further comprises a second actuator that is operatively connected to the door and is configured to move the door between the second position and the first position. The second actuator is formed from a shape memory alloy transitionable between a first state and a second state in response to a change in temperature of the shape memory alloy of the second actuator, and the shape memory alloy of the second actuator transitions between the first state and the second state to move the door from the second position to the first position. A bi-stable spring is operatively connected to the door and biases the door to the first position when the door is in the first position, and biases the door to the second position when the door is in the second position. Accordingly, power is provided to one or the other actuator to move the door, and then the bi-stable spring will retain the door in the desired first or second position until the other actuator is powered.

In another example of a drying system that is configured so that the power need not remain on to the actuator in order to keep the door in the first position, the drying system comprises a releasable latch that is configured to latch the door in the second position. Accordingly, once the actuator is activated to move the door to the second position, the latch will retain the door in the second position, and electrical power to the actuator can be off. Stated differently, the drying system may include a power source selectively connectable to the actuator to electrically energize the actuator, thereby heating the actuator such that the shape memory alloy transitions from the first state to the second state. The power source is disconnected from the actuator when the releasable latch holds the door in the second position.

In some embodiments, the releasable latch is configured so that a subsequent actuation of the actuator will cause the door to be released from the releasable latch. Accordingly, when the door is held in the second position by the releasable latch and the power source is connected to the actuator to electrically energize the actuator, the releasable latch is configured to release the door.

In other embodiments, the drying system includes a separate shape memory alloy actuator to release the releasable latch from the door. For example, the actuator that moves the door is a first actuator, and the assembly may further include a second actuator operatively connected to the releasable latch. The second actuator is formed from a shape memory alloy transitionable between a first state and a second state in response to a change in temperature of the shape memory alloy of the second actuator, and the shape memory alloy of the second actuator transitions between the first state and the second state to release the releasable latch from the door. A heating element may be disposed in the outer chamber and may be electrically energizable to heat the rechargeable desiccant sufficiently to remove moisture absorbed by the rechargeable desiccant. The power source may be selectively connectable to the second actuator to electrically energize the second actuator, thereby heating the second actuator such that the shape memory alloy of the second actuator transitions from the first state to the second state. The power source may be separately selectively connectable to the heating element to electrically energize the heating element. An electronic controller may be operable to separately selectively connect the power source to the first actuator, to the second actuator, and to the heating element.

In accordance with the present teachings, a lamp drying system may comprise a lamp assembly including a housing and a lens mounted to the housing such that the housing and the lens define an interior space. The housing has an inner wall dividing the interior space into an inner chamber and an outer chamber, and the lens is mounted to the housing at the inner chamber. The inner wall has a first opening through which the inner chamber communicates with the outer chamber. A rechargeable desiccant is disposed in the outer chamber. A door is disposed in the outer chamber and is configured to be movable between a first position and a second position. The door is configured to at least partially seal the second opening and unseal the first opening when in the first position, and at least partially seal the first opening and unseal the second opening when in the second position. An actuator is operatively connected to the door and is configured to move the door between the first position and the second position. The actuator is formed from a shape memory alloy transitionable between a first state and a second state in response to a change in temperature of the shape memory alloy. The shape memory alloy transitions between the first state and the second state to move the door from the first position to the second position. The rechargeable desiccant is disposed in sufficient proximity to the actuator such that electrical energizing of only one of the actuator or the rechargeable desiccant is sufficient to both cause the shape memory alloy to transition from the first state to the second state and remove moisture absorbed by the rechargeable desiccant.

The above features and advantages and other features and advantages of the present disclosure are readily apparent from the following detailed description of the best modes for carrying out the disclosure when taken in connection with the accompanying drawings.

### BRIEF DESCRIPTION OF THE DRAWINGS

FIG. 1 is a cross-sectional view of a lamp drying system including a lamp assembly taken at lines 1-1 in FIG. 2, with a door in a first position.

FIG. 2 is a cross-sectional view of the lamp assembly of FIG. 1 taken at lines 2-2 in FIG. 1.

FIG. 3 is a rear view of the lamp assembly of FIG. 1.

FIG. 4 is a cross-sectional view of the lamp drying system of FIG. 1 taken at lines 4-4 in FIG. 5 and with the door in a second position.

FIG. 5 is a cross-sectional view of a lamp assembly of FIG. 4 taken at lines 5-5 in FIG. 4.

FIG. 6 is a rear view of the lamp assembly of FIG. 4.

FIG. 7 is a cross-sectional view of an alternative lamp drying system with a door in a first position, and showing the door in phantom in a second position.

FIG. 8 is a cross-sectional view of an alternative lamp drying system with a door in a first position, and showing the door in phantom in a second position.

FIG. 9 is a cross-sectional view of an alternative lamp drying system including a lamp assembly with a door in a first position.

FIG. 10 is a cross-sectional view of the lamp drying system of FIG. 9 with the door in a second position.

FIG. 11 is a cross-sectional view of the lamp assembly of FIG. 10 taken at lines 11-11 in FIG. 10.

FIG. 12 is a cross-sectional view of an alternative lamp drying system having a releasable latch and with a door in a first position.

FIG. 13 is a cross-sectional view of the lamp drying system of FIG. 12 with the door moving toward a second position.

FIG. 14 is a cross-sectional view of the lamp drying system of FIG. 12 with the door latched in the second position by the releasable latch.

FIG. 15 is a cross-sectional view of the lamp assembly of FIG. 14 taken at lines 15-15 in FIG. 14.

FIG. 16 is a cross-sectional view of the lamp drying system of FIG. 12 with the door moving toward the first position.

FIG. 17 is a schematic illustration in fragmentary view of an alternative releasable latch for the lamp assembly of FIG. 12.

### DETAILED DESCRIPTION

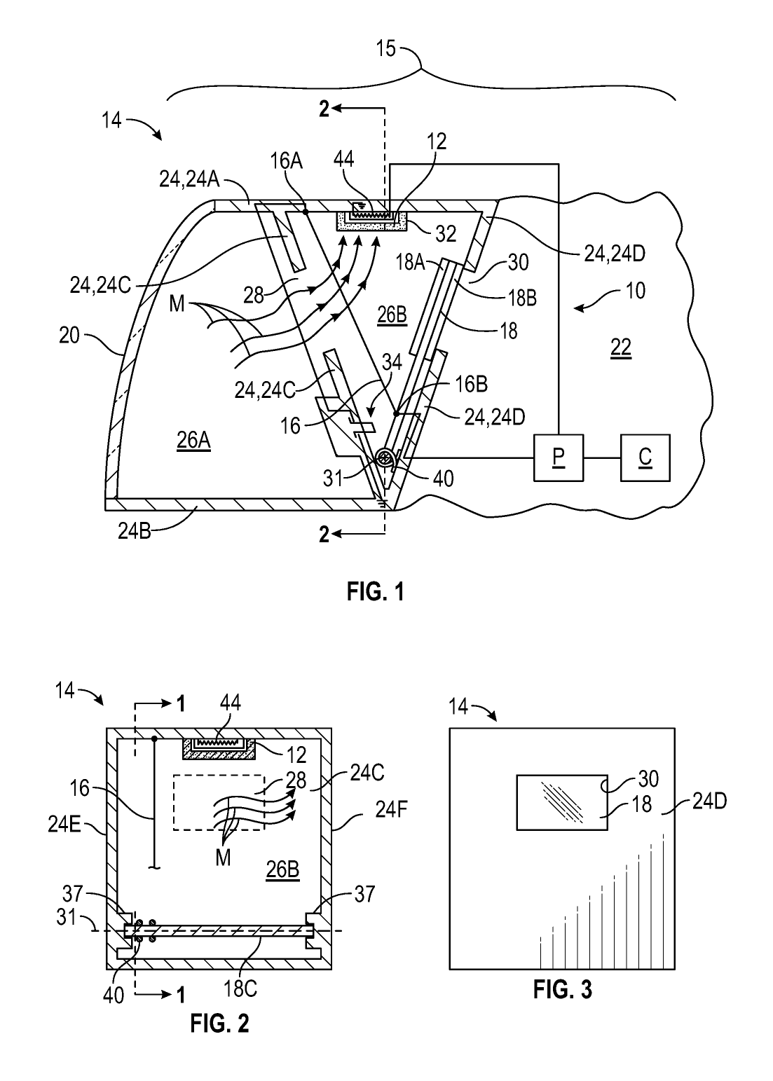

Referring to the drawings, wherein like reference numbers refer to like components throughout the views, FIG. 1 shows a lamp drying system 10 that utilizes a rechargeable desiccant 12 to absorb moisture within a lamp assembly 14. When the desiccant 12 is sufficiently heated, it releases the moisture such that it is “recharged”, i.e., and has greater capacity to absorb moisture. An actuator 16 formed from a shape memory alloy (SMA) is used to move a door 18 to control airflow within and out of the lamp assembly 14 so that a lens 20 is shielded from moisture released during recharging of the desiccant 12. The lens 20 is transparent and is configured to allow light to pass through from a light source such as a bulb (not shown) disposed in an inner chamber 26A of the lamp assembly 14. The lens 20 will obscure the light. Accordingly, the lamp drying system 10 enables repeated absorption and expelling of moisture as discussed herein.

The actuator 16 may be referred to as an SMA actuator. The use of a rechargeable desiccant 12 extends the ability to dry the interior of the lamp assembly 14, alleviating condensation or fogging of a lens 20. The use of a shape memory alloy actuator 16 is smaller, lighter, and may present cost savings as well as reduce the number of components.

The lamp assembly 14 as shown is a vehicle lamp assembly, such as a headlight assembly, and is positioned in a vehicle 15 (represented only in part) adjacent to an engine compartment such that the engine compartment is an exterior environment 22 of the lamp assembly 14. The exterior environment 22 is indicated in part. Instead of a headlight assembly, the lamp assembly 14 could be other vehicle lamp assemblies, such as taillight or even an interior lamp assembly. In other examples, the assembly may be a sensor assembly having an emitting or receiving component at the interior space for which moisture could affect performance or aesthetics. Accordingly, the systems 10, 110, 210, 310, 410, and assemblies 14, 114, 214, 314, 414 are not limited to a vehicle application or a lamp application.

The vehicle may be autonomous or driven by a human, and may include, but not be limited to a mobile platform in the form of a commercial vehicle (car, truck, sport utility vehicle, etc.), industrial vehicle (bus, etc.), agricultural vehicle, passenger vehicle, aircraft, watercraft, train, all-terrain vehicle, personal movement apparatus, robot and the like to accomplish the purposes of this disclosure.

The lamp assembly 14 includes a housing 24. The lens 20 is mounted to the housing 24 such that the housing and the lens together define an interior space 26A, 26B that has an inner chamber 26A and an outer chamber 26B. The housing 24 has an upper wall 24A, a lower wall 24B, an inner wall 24C, an outer wall 24D, and first and second sidewalls 24E, 24F. The sidewalls 24E, 24F are best shown in FIG. 2. The walls 24A, 24B, 24C, 24D, 24E, 24F and the lens 20 define the interior space 26A, 26B. The inner wall 24C divides the interior space into the inner chamber 26A and the outer chamber 26B. The lens 20 is mounted to the housing 24 at the inner chamber 26A, and partially defines the inner chamber 26A.

The inner wall 24C has a first opening 28 through which the inner chamber 26A communicates with the outer chamber 26B. The outer chamber 26B is between the inner wall 24C and the outer wall 24D. The outer wall 24D has a second opening 30 with which the outer chamber 26B communicates with the exterior environment 22. The first opening 28 may be referred to as an inner opening, and the second opening 30 may be referred to as an outer opening. The rechargeable desiccant 12 is disposed in the outer chamber 26B. In the example shown, the rechargeable desiccant 12 is contained within a container 32 that is secured to the upper wall 24A within the outer chamber 26B. The container 32 allows the desiccant 12 to be exposed to the air in the outer chamber 26B. For example, the container 32 may include vents so that air in the outer chamber 26B reaches the rechargeable desiccant 12. The container 32 may also be integrally formed with the upper wall 24A. The rechargeable desiccant 12 may be a commercially available absorbent salt or a mixture of salts that absorb moisture such as but not limited to calcium chloride, or magnesium chloride.

As discussed herein, the lamp system 10 includes a door 18 that is selectively moveable by the SMA actuator 16 to at least partially alternately block and seal the first opening 28 and the second opening 30 in coordination with drying of the interior space 26A, 26B by the desiccant 12.

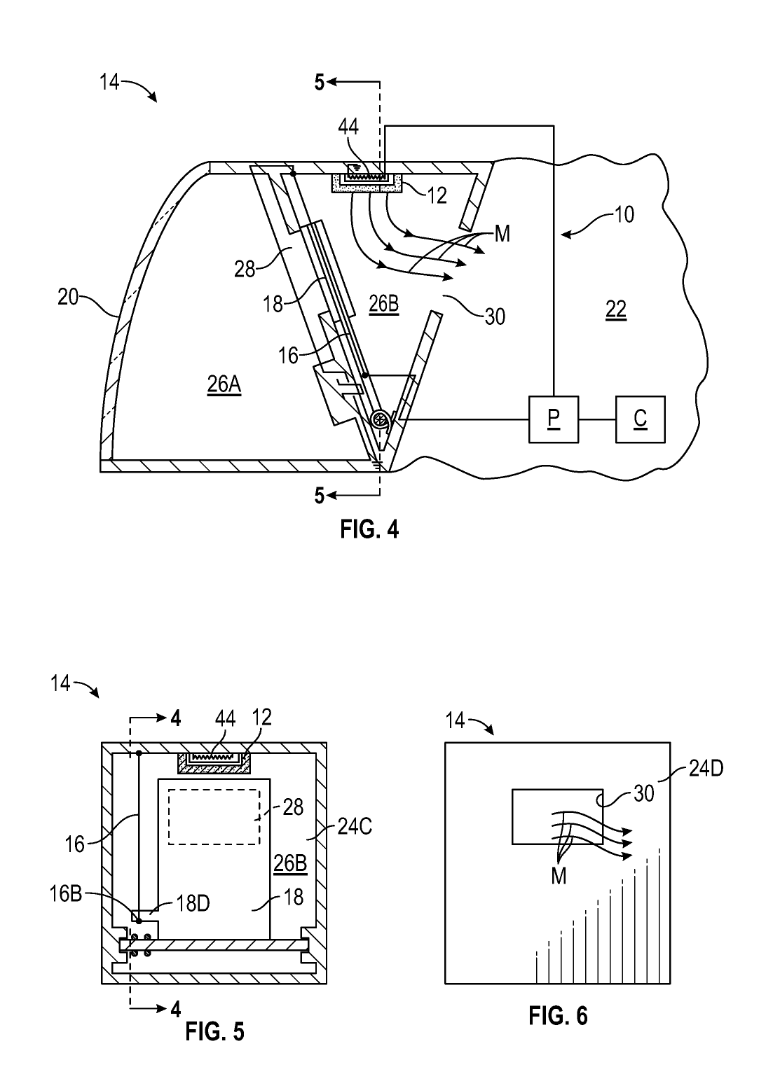

The SMA actuator 16 is operatively connected to the door 18, which is disposed in the outer chamber 26B and is configured to be movable by the SMA actuator 16 between a first position shown in FIG. 1, and a second position shown in FIG. 4. The door 18 is configured to at least partially seal the second opening 30 and unseal the first opening 28 when in the first position as shown in FIG. 1, and at least partially seal the first opening 28 and unseal the second opening 30 when in the second position as shown in FIG. 4. The door 18 may include compressible material 18A, 18B in the form of pads or flanges, mounted on inner and outer faces of the door, that surround and help to seal the respective openings 28, 30.

The SMA actuator 16 may be configured as a wire with a first end 16A anchored to the housing 24, and a second end 16B anchored to the door 18. The second end 16B may be secured to an extension 18D of the door 18, best shown in FIG. 5. As is evident in FIGS. 2 and 5, the SMA actuator 16 is thus positioned laterally outward of a side edge of the door 18, and does not interfere with the pivoting of the door 18.

The door 18 is pivotably secured to the housing 24 and pivots about a pivot axis 31 when the door 18 moves from the first position to the second position. Such pivoting motion may be referred to as articulation. As best shown in FIG. 2, a lower end 18C of the door 18 is pivotably held in mounts 37 relative to the sidewalls 24E, 24F of the housing 24 so that the door 18 pivots about a pivot axis 31 between the first and second positions.

A biasing spring 40 biases the door 18 to the first position. Accordingly, the door 18 is maintained in the first position by the mechanical force of the spring 40 and in the absence of any electrical power. The biasing spring 40 is shown as a torsion spring centered around the lower end 18C of the door 18, and has one end secured to the door and the other end secured to the outer wall 24D. Other types of biasing springs may be used within the scope of the present teachings. Pivoting of the door 18 counter-clockwise in FIG. 1 about the pivot axis 31 tightens the spring 40.

In the wire form, the SMA actuator 16 contracts in length in response to a sufficient increase in temperature. For example, the SMA actuator 16 is formed from a shape memory alloy transitionable between a first state (FIG. 1) and a second state (FIG. 2) in response to a change in temperature of the shape memory alloy. The change in temperature may be effected by heat such as from Joule heating or an electric current passed through resistance; or from an external heat source, such as a radiative heating element, a ceramic heating element, and the like. Therefore, as set forth in more detail below, the SMA actuator 16 may transition between the first state and the second state to move the door 18 between the first position and the second position. The contraction in length of the SMA actuator 16 provides sufficient force on the door 18 to overcome the biasing force of the spring 40, and cause the door 18 to pivot to the second position. In any of the embodiments disclosed herein, one or more force transmission elements may be disposed to interface with the wire to amplify or redirect its shrinkage. For example, a lever arm, gears, or a sliding element may interface with the SMA actuator 16 or any of the SMA actuators shown herein.

In the lamp drying system 10 of FIG. 1, the SMA actuator 16 is electrically energized by an electric current provided by a power source P in response to a control signal from an electronic controller C. An electric current provided from the power source P energizes the SMA actuator 16 when a circuit is formed by the SMA actuator 16 and conductive wires connected between the ends 16A, 16B with a switch 34 in the closed position shown in FIG. 1. Wires representing transfer conductors to connect the power source P to SMA actuators(s) or to heating elements 44 shown herein are illustrated where helpful for discussion purposes and are shown partially outside of the housing 24 in some of the views for illustrative purposes. It should be appreciated that the wires could extend within or along the surfaces of the housing 24. The electronic controller C may have a stored algorithm that determines when the rechargeable desiccant 12 should be recharged, and hence when the SMA actuator 16 should be electrically energized. The algorithm may be based on sensor input, such as sensors within the interior space 26A, 26B that measure moisture or temperature. The algorithm could simply be a timer that periodically recharges the rechargeable desiccant 12. In a vehicle application, the power source P may be, for example, a battery.

As used herein, the terminology “shape memory alloy” refers to an alloy that exhibits a shape memory effect and has the capability to quickly change properties in terms of stiffness, spring rate, and/or form stability. That is, the shape memory alloy may undergo a solid state crystallographic phase change via molecular or crystalline rearrangement to shift between a martensite phase, i.e., “martensite”, and an austenite phase, i.e., “austenite”. That is, the shape memory alloy may undergo a displacive transformation rather than a diffusional transformation to shift between martensite and austenite. A displacive transformation is defined as a structural change that occurs by a coordinated movement of atoms or groups of atoms relative to neighboring atoms or groups of atoms. Further, the martensite phase generally refers to a comparatively lower-temperature phase and is often more deformable than the comparatively higher-temperature austenite phase.

The temperature at which the shape memory alloy begins to change from the austenite phase to the martensite phase is characterized as the martensite start temperature, Ms. The temperature at which the shape memory alloy completes the change from the austenite phase to the martensite phase is characterized as the martensite finish temperature, Mf Similarly, as the shape memory alloy is heated, the temperature at which the shape memory alloy begins to change from the martensite phase to the austenite phase is characterized as the austenite start temperature, As. The temperature at which the shape memory alloy completes the change from the martensite phase to the austenite phase is characterized as the austenite finish temperature, Af.

The shape memory alloy may have a suitable form, i.e., shape. For example, the SMA actuator 16 may be configured as a shape-changing element such as a wire (FIGS. 1 and 2), spring, first resilient member, tape, band, and combinations thereof. Further, the shape memory alloy may have a suitable composition. In particular, the shape memory alloy may include in combination an element selected from the group of cobalt, nickel, titanium, indium, manganese, iron, palladium, zinc, copper, silver, gold, cadmium, tin, silicon, platinum, and gallium. For example, suitable shape memory alloys may include nickel-titanium based alloys, nickel-aluminum based alloys, nickel-gallium based alloys, indium-titanium based alloys, indium-cadmium based alloys, nickel-cobalt-aluminum based alloys, nickel-manganese-gallium based alloys, copper based alloys (e.g., copper-zinc alloys, copper-aluminum alloys, copper-gold alloys, and copper-tin alloys), gold-cadmium based alloys, silver-cadmium based alloys, manganese-copper based alloys, iron-platinum based alloys, iron-palladium based alloys, and combinations of one or more of each of these combinations. The shape memory alloy can be binary, ternary, or a higher order so long as the shape memory alloy exhibits a shape memory effect, e.g., a change in shape orientation, damping capacity, and the like. Generally, the shape memory alloy may be selected according to desired operating temperatures of the lamp assembly 14 and lamp drying system 10. In one specific example, the shape memory alloy may include nickel and titanium.

Therefore, in one non-limiting example illustrated in FIGS. 1-2, the SMA actuator 16 may be configured as the wire. The wire formed from the shape memory alloy may be characterized by the first state (FIG. 1), i.e., when a temperature of the shape memory alloy is below the martensite finish temperature, Mf of the shape memory alloy. Likewise, the wire formed from the shape memory alloy may also be characterized by the second state (FIG. 4), i.e., when the temperature of the shape memory alloy is above the austenite finish temperature, Af of the shape memory alloy. In addition, although not shown, the lamp assembly 14 and lamp drying system 10 may include a plurality of shape memory alloys and/or a plurality of wires, each having one end connected to the housing 24 and one end connected to the door 18 in parallel with the single SMA actuator 16 shown.

In one example, the change in temperature at which the SMA actuators described herein transition from the first state to the second state and the temperature at which the desiccant is regenerated are the same, or are compatible such that heat released from one activates the other as described herein. For example, the SMA actuator may transition from the first state to the second state when the temperature rises from an ambient temperature to 110 degrees Celsius, and the desiccant 12 may be regenerated at a temperature of 110 degrees Celsius or at a temperature that occurs in the vicinity of the SMA actuator 16 when it is heated to 110 degrees Celsius.

Therefore, for embodiments in which the SMA actuator 16 is configured as the wire, the wire may contract in length in response to the change in temperature that results from energizing the SMA actuator 16 (FIG. 4), causing the SMA actuator 16 to transition from the first state to the second state, to pivot the door 18 from the first position (FIG. 1) to the second position (FIG. 4), and thereby open the outer opening 30 and close the inner opening 28. Conversely, the door 18 may pivot from the second position of FIG. 4 to the first position of FIG. 1 as the SMA actuator 16 cools and transition from the second state to the first state, such as when power from the power source P is no longer provided.

In other words, as the shape memory alloy warms, the SMA actuator 16 contracts in length and pulls the door 18 where it is connected to the door 18 at its second end 16B. Because the second end 16B is offset from the pivot axis 31, this causes the door 18 to pivot to the second position of FIG. 4, overcoming the biasing force of the spring 40. Conversely, as the shape memory alloy cools, the SMA actuator 16 expands in length such that the force of the biasing spring 40 returns the door 18 to the first position.

Accordingly, when the door 18 is in the first position, the exterior environment 22 is blocked from both chambers 26A, 26B, the first chamber 26A is in communication with the second chamber 26B through the first opening 28, and the desiccant 12 removes moisture M from both chambers 26A, 26B as shown in FIGS. 1 and 2. The rechargeable desiccant 12 is not recharged when the door 18 is in the first position so that moisture is not released into the chamber 26A and the lens 20 is not fogged. Instead, recharging of the desiccant 12 occurs when the door 18 is in the second position sealing the opening 28 (FIGS. 4 and 5), protecting the inner chamber 26A and the lens 20 from moisture released from the desiccant 12, while the outer chamber 26B is in communication with the exterior environment 22 through the opening 30 (FIGS. 4 and 6), allowing moisture M released from the rechargeable desiccant 12 during regeneration of the desiccant to be expelled from the outer chamber 26B through the opening 30 to the exterior environment 22. The flow of moisture in the air is generally depicted by arrows M.

The lamp drying system 10 may be referred to as a “power on” system, as power is provided to the SMA actuator 16 to counteract the biasing force of the spring 40 and keep the door 18 in the second position during regeneration of the rechargeable desiccant 12. The power may be kept on continuously during the regeneration until the desiccant 12 is fully regenerated, or, due to the switch 34, may be intermittently shut off, but not for a long enough period to allow the door 18 to shift significantly from the opening 28. For example, the switch 34 may be a normally-closed switch. In FIG. 1, the switch 34 is in a closed position. When the door 18 moves to the second position of FIG. 4, the switch 34 may be pushed open as shown in FIG. 4, opening the circuit so that the SMA actuator 16 is no longer energized and begins to cool. As the SMA actuator 16 begins to cool, the wire begins to extend in length and the door 18 begins moving toward the first position. This causes the switch 34 to close, enabling electrical energy from the power source P to again heat the SMA actuator 16 causing it to contract, moving the door 18 back to the second position. In this manner, the power toggles on and off while the door 18 shifts slightly away from the second position and then back to the second position. The compressible material 18A on the door 18 may have enough compressibility such that it maintains a seal against the inner wall 24C even with this slight pivoting of the door 18 due to the switch 34.

When the door 18 is in the second position, the controller C causes the power source P to direct electrical energy to the heating element 44 disposed in the second chamber 16B adjacent to the desiccant 12. The heating element 44 may be a conductive material heated by resistive heating, for example. The controller C may close a switch within the power source P or between the power source P and the heating element 44 to direct electrical energy to the heating element 44. As indicated in FIGS. 4 and 6, the heating element 44 heats the rechargeable desiccant 12 sufficiently to remove moisture M absorbed by the rechargeable desiccant 12, causing it to be expelled from the rechargeable desiccant 12 and out of the opening 30 to the exterior environment 22.

When the desiccant 12 is sufficiently dry, power to the heating element 44 is terminated, and the SMA wire 16 cools, returning the door 18 to its nominally closed position (the first position of FIG. 1). Termination of power from the power source P to the heating element 44 may be accomplished by opening a switch in the power source P or between the power source P and the heating element 44, and may be controlled by the controller C based on a timer (i.e., a predetermined drying time over which the heating element 44 is powered), or based on sensors that sense the weight of the desiccant 12, which may be correlated to moisture content, or sensors that directly sense the moisture level of the desiccant 12.

The heating element 44 and the SMA actuator 16 are thus separately electrically energized in the lamp drying system 10 of FIG. 1. For example, the power source P is selectively connectable to the actuator 16 to electrically energize the actuator 16, thereby heating the shape memory alloy such that the shape memory alloy transitions from the first state to the second state, and the power source P is selectively connectable to the heating element 44 separately from the actuator 16 to electrically energize the heating element 44. The electronic controller C is operable to selectively connect the power source P to the SMA actuator 16, and to separately selectively connect the power source P to the heating element 44.

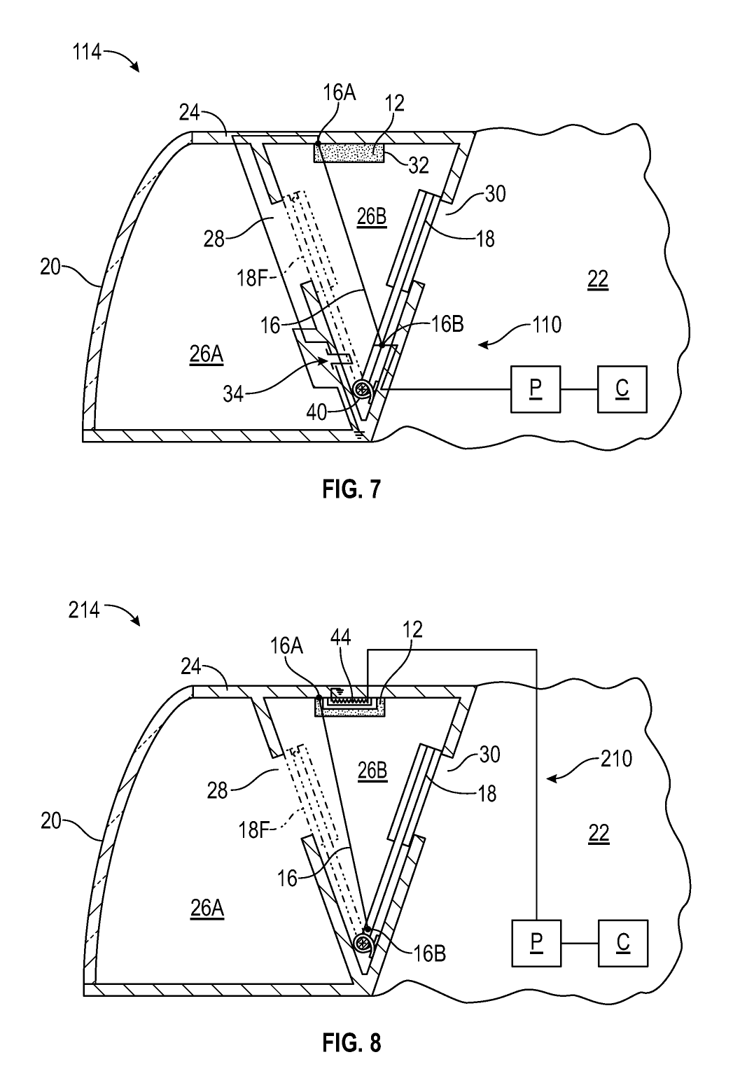

In other embodiments, heating of the SMA actuator 16 (and the resulting articulation of the door 18) and heating of the rechargeable desiccant 12 may be integrated to reduce the number of components and/or the complexity of the electrical connections. For example, in FIG. 7, a lamp drying system 110 is shown with a lamp assembly 114 that has the same components functioning in the same manner as described with respect to lamp drying assembly 10 and lamp system 14, except that there is no heating element 44 for the rechargeable desiccant 12. Instead, the rechargeable desiccant 12 is disposed in sufficient proximity to the SMA actuator 16 such that heat from the SMA actuator 16 heats the rechargeable desiccant 12 to remove moisture M absorbed by the rechargeable desiccant. For example, the first end 16A of the SMA actuator 16 is moved further toward the outer wall 24D than in FIG. 1, and the rechargeable desiccant 12 is moved closer to the sidewall 24E than in FIG. 1 so that the heat radiating from the SMA actuator 16 when it is energized (i.e., when it is transitioning to and when it is in the second state) is sufficient to heat the rechargeable desiccant to dry the desiccant 12 when the door 18 is in the second position (shown in phantom at 18F in FIG. 7). The power source P is selectively connectable to the SMA actuator 16 via the electronic controller C to electrically energize the SMA actuator 16, thereby heating the shape memory alloy such that the shape memory alloy transitions from the first state to the second state, but there is no heating element and no separate electrical circuit for the power source P for heating the desiccant 12.

FIG. 8 shows another lamp drying system 210 with a lamp assembly 214, in which the system 210 integrates actuation of the SMA actuator 16 and recharging of the rechargeable desiccant 12. The lamp drying system 210 includes the heating element 44 disposed in the outer chamber 26B and electrically energizable by the power source P to heat the rechargeable desiccant 12 sufficiently to remove moisture absorbed by the rechargeable desiccant 12. The SMA actuator 16, however, is not operatively connected to the power source P and is not electrically energizable. Instead, the first end 16A of the SMA actuator is slightly more toward the outer wall 24D than in FIG. 1, and the rechargeable desiccant 12 is moved closer to the sidewall 24E than in FIG. 1 so that the actuator is disposed in sufficient proximity to the heating element 44 such that the shape memory alloy of the SMA actuator 16 is transitionable from the first state to the second state in response to heat from the heating element 44. The power source P is selectively connectable to the heating element 44 via the electronic controller C to electrically energize the heating element 44, thereby drying the desiccant 12 while at the same time the SMA actuator 16 transitions to the second state, pivoting the door 18 to the second position (shown in phantom in FIG. 8 as 18F). However, there is no separate electrical circuit for the power source P for SMA actuator 16. Because the SMA actuation and desiccant drying functions are integrated, the lamp drying systems 110, 210 may save electrical energy in comparison to the lamp drying system 10.

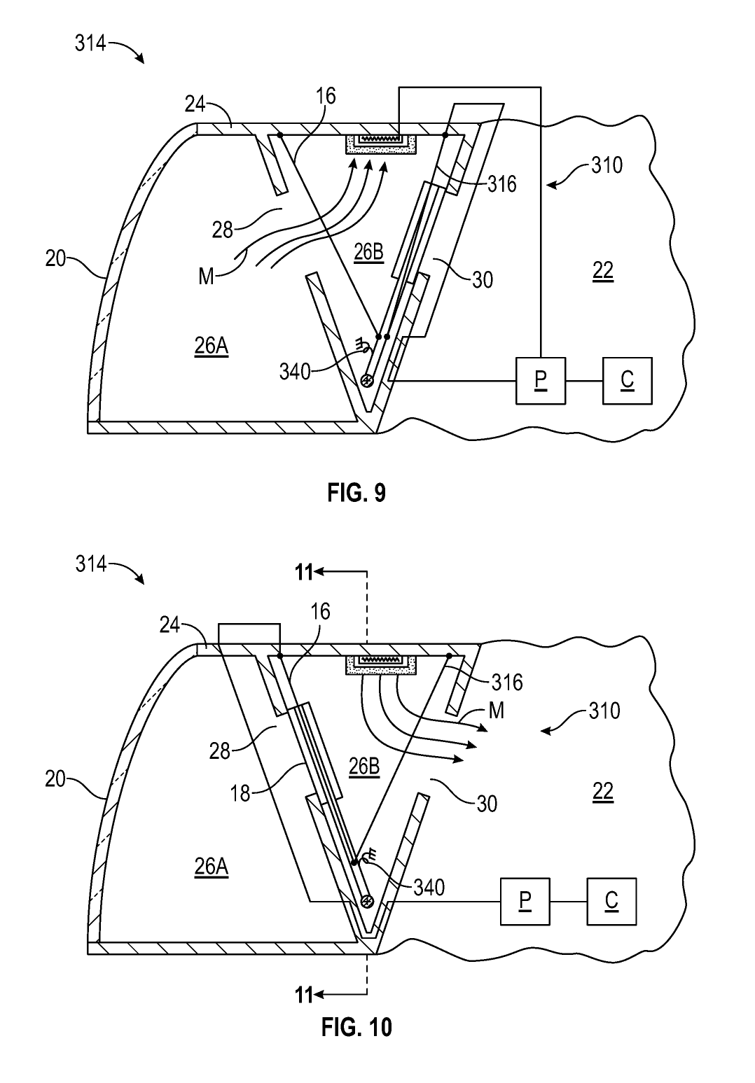

FIGS. 9-11 show an alternative example of a lamp drying system 310 that has two antagonistic SMA actuators 16 and 316, and a bi-stable spring 340 (instead of a biasing spring 40 that provides a biasing force on the door 18 in only one direction) to achieve power savings, as power need not remain on to the actuator 16 in order to keep the door 18 in the second position of FIG. 10. Instead, power is required to one or the other of the SMA actuators 16, 316 when it is time to move the door 18 from the first position to the second position, or from the second position to the first position. The SMA actuator 16 may be referred to as a first actuator, and the SMA actuator 316 may be referred to as a second actuator. The SMA actuator 316 is configured to move the door between the second position and the first position (i.e., pivots the door in the opposite direction as the SMA actuator 16 when energized). The second SMA actuator 316 is formed from a shape memory alloy transitionable between a first state and a second state in response to a change in temperature of the shape memory alloy of the second actuator 316 to move the door 18 from the second position to the first position. In other words, the SMA actuator 316 is electrically energized by the power source P under the control of the controller C to contract, causing the door 18 to pivot from the second position of FIG. 10 to the first position of FIG. 9.

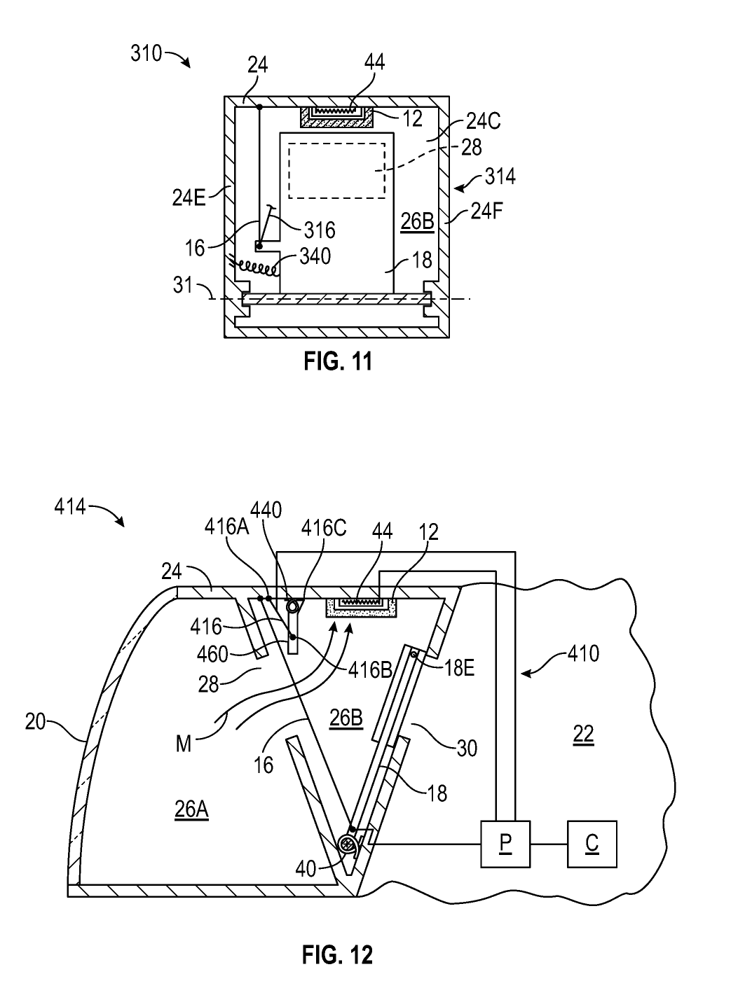

The bi-stable spring 340 is operatively connected to the door 18. More specifically, one end of the bi-stable spring 340 is connected to the door 18, and the other end is fixed to the housing, such as to the sidewall 24E at a point midway between the first and second positions of the door 18, as shown in FIG. 11. The bi-stable spring 340 is a compression spring, leaf spring, or tension spring, and is biased to the length it adopts when the door 18 is in the first positon or in the second position. For example, if the bi-stable spring 340 is a compression spring, it is compressed when the door 18 is at a position between the first and second positions, so that it biases the door 18 back toward the closer one of the first or the second positions. The spring 340 thus biases the door 18 to the first position when the door is in the first position, and biases the door 18 to the second position when the door is in the second position. Accordingly, power is provided to one or the other actuator 16, 316 to move the door 18, and then the bi-stable spring 340 will retain the door in the desired first or second position until the other actuator is powered. As in the lamp drying systems 10, 110, 210, when the door 18 is in the second position, the desiccant 12 is heated to recharge the desiccant 12, releasing absorbed moisture M to the exterior environment through the outer opening 30, while the door 18 seals the inner opening 28 to protect the inner chamber 26A and lens 20 from the released moisture M.

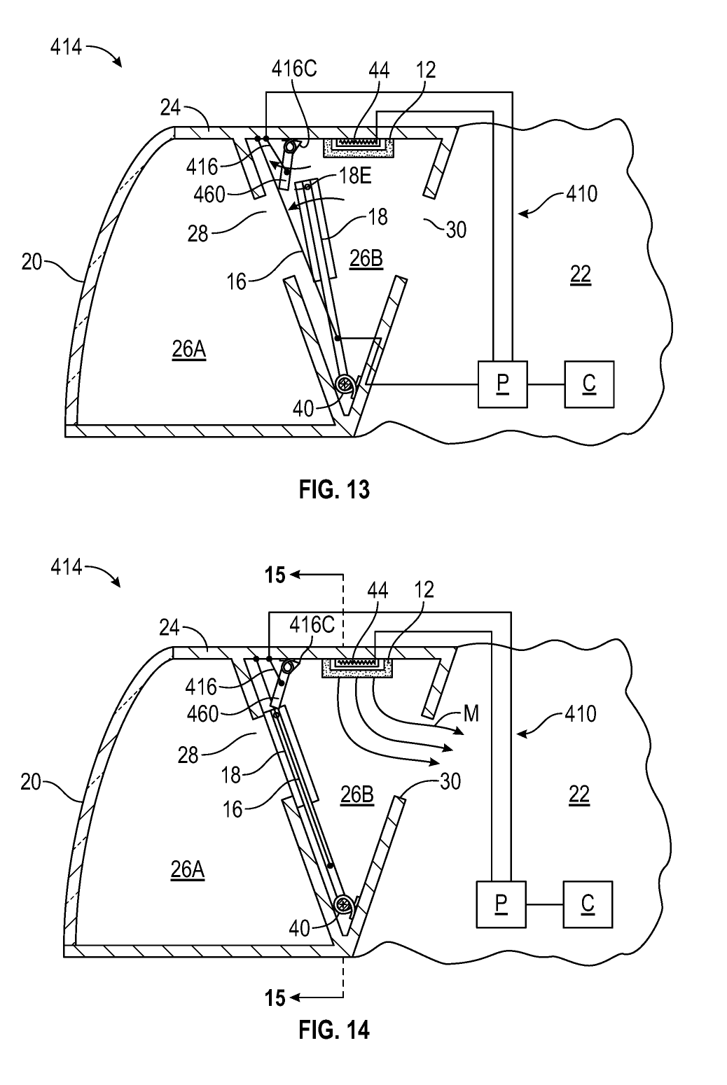

FIGS. 12-16 show another example of a lamp drying system 410 with a lamp assembly 414 that provides an opportunity to reduce electrical power requirements in comparison to a lamp drying system with a “power on” SMA actuator like that of lamp drying system 10, as power need not remain on to the first actuator 16 in order to keep the door 18 in the second position of FIG. 14. The lamp assembly 314 has many of the same components functioning in the same manner as described with respect to lamp drying assembly 14. The lamp drying system 410 includes a releasable latch 460 mounted to the housing 24 in the second chamber 26B and configured to latch the door 18 in the second position of FIG. 14. The latch 460 is biased by a biasing spring 440 to the position of FIG. 12. The door 18 may include a transversely projecting post 18E or be otherwise configured so that it interferes with the releasable latch 460 when the door 18 pivots from the first position of FIG. 12 to the second position of FIG. 14, overcoming the biasing spring 40, as the SMA actuator 16 is energized. The post 18E interfering with the latch 460 is best shown in FIG. 13. The force of the post 18E on the latch 460 due to the contracting SMA actuator 16 overcomes the force of biasing spring 440 and causes the latch 460 to rotate out of the way of the door 18.

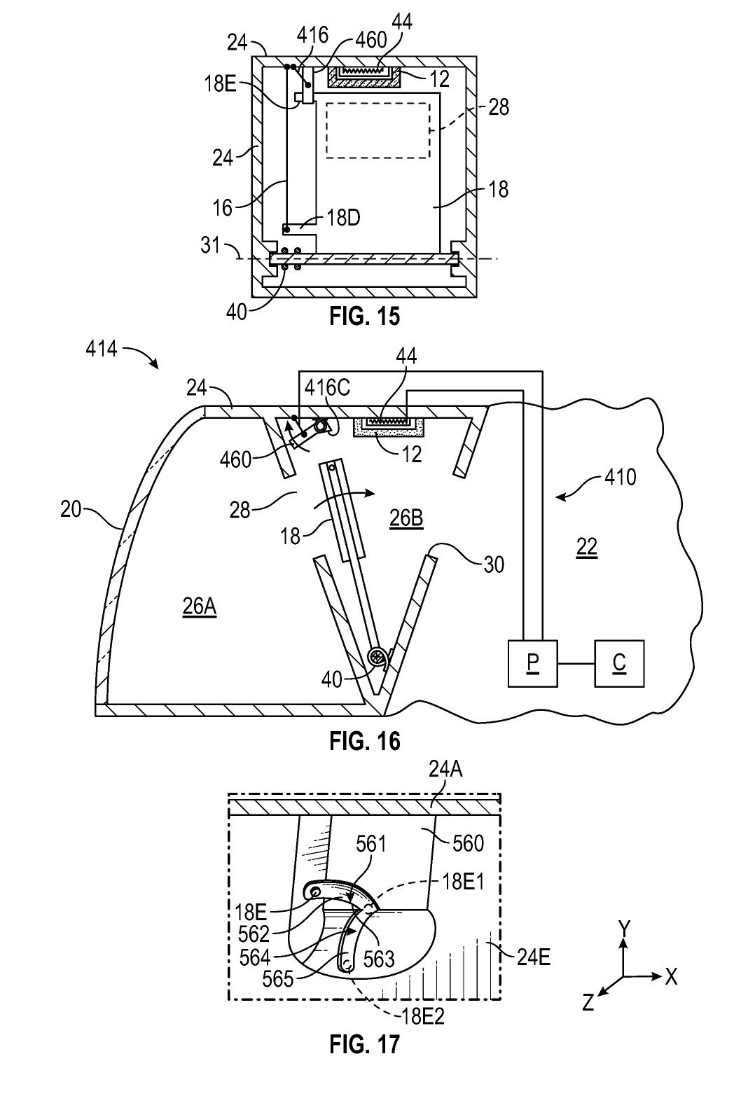

A second SMA actuator 416 has one end 416A connected to the housing 24 and a second end 416B connected to the releasable latch 460. The SMA actuator 416 is formed from a shape memory alloy is transitionable between a first state (FIGS. 12-15) and a second state (FIG. 16) in response to a change in temperature of the shape memory alloy of the second SMA actuator 416. The SMA actuator 416 is configured as a wire, and the shape memory alloy of the SMA actuator 416 transitions between the first state and the second state to release the releasable latch 460 from interfering with the post 18E of the door 18 so that the door 18 returns to the first position due to the spring 40. As shown in FIG. 15, the SMA actuator 416 is connected to the housing 24 and the latch 460 so that when it is energized, it contracts in a direction along the pivot axis 31 of the door 18 so that it clears the way for the door 18 to pass back to the first position of FIG. 12 under the force of the biasing spring 40.

In FIG. 12, with the door 18 in the first position sealing the opening 30, neither of the SMA actuators 16, 416 are energized. In FIG. 13, the first SMA actuator 16 is energized and the second SMA actuator 416 is not energized. In FIG. 14, once the door 18 is moved to the second position under the force of the contracting SMA actuator 16, the releasable latch 460 latches the door 18 in the second position, and the SMA actuator 16 is no longer energized. The SMA actuator 416 is also not energized, and the latch 460 maintains the door 18 in the second position due to an inability of the latch 460 to move counterclockwise in FIG. 13 beyond the first position to which it is biased by the spring 440. For example, a base 416C of the latch 460 may interfere with the housing 24 to prevent its further rotation.

When the door 18 is latched in the second position of FIG. 14, the heating element 44 is powered by the power source P to recharge the desiccant 12, and moisture M exits the opening 30, while the door seals the opening 28 to protect the inner chamber 26A and the lens 20 from the expelled moisture M. Once drying is complete, as determined by the controller C as discussed above, the SMA actuator 416 is energized by the power source P under the control of the controller C causing the shape memory alloy to contract in length, to move the latch 460 out of the way of the post 18E, allowing the force of the biasing spring 40 to cause the door 18 to return to the first position. Accordingly, in FIG. 16, the SMA actuator 416 is energized and the SMA actuator 16 is not energized. The electronic controller C is operable to separately selectively connect the power source P to the first actuator 16, to the second actuator 416, and to the heating element 44 in the lamp drying system 410.

FIG. 17 shows an alternative embodiment of a releasable latch 560 for use in the lamp drying system 410 instead of releasable latch 460. A second SMA actuator is not needed to release the releasable latch 560 from the door 18. Instead, the releasable latch 560 is geometrically configured with cam surfaces so that if the power source P electrically energizes the first SMA actuator 16 when the door 18 is being held in the second position by the releasable latch 560, the contracting SMA actuator 16 will move along the latch 560 to release the door 18.

The releasable latch 560 is shown from a viewpoint generally looking toward the side wall 24E of the housing 24, with the post 18E in cross-sectional view. A first electrical energizing of the SMA actuator 16 moves the door 18 from the first position to the second position, and the post 18E of the door 18 slides along a first cam surface 561 in a first track 562 of the releasable latch 560 as the SMA actuator 16 is contracting until it rests against the latch 560 at a stop 563 (post represented as 18E1) due to the biasing force of the spring 40, so that the door 18 does not return to the first position even with power to the SMA actuator 16 then terminated.

When the desiccant 12 is sufficiently dried, and the door 18 is to be returned to the first position to close the opening 30, the power source P again electrically energizes the SMA actuator 16. The contracting SMA actuator 16 then causes the post 18E to slide along a second cam surface 564 in a second track 565 of the releasable latch 560, with the post represented as 18E2. The first cam surface 561 is such that the path of the post 18E in the first track 562 is generally in the X-Y plane in FIG. 17. The second cam surface 564 is such that the path of the post 18E in the second track 565 is generally in the Y-Z plane in FIG. 17. When the post 18E is in the second track 565, the SMA actuator 16 need not be powered, as the biasing force of the spring 40 will cause the post 18E to slide along the second cam surface 564 and return the door 18 to the first position.

While the best modes for carrying out the disclosure have been described in detail, those familiar with the art to which this disclosure relates will recognize various alternative designs and embodiments for practicing the disclosure within the scope of the appended claims.

What is claimed is:

1. A drying system comprising:
an assembly including a housing defining an interior space;
wherein the housing has an inner wall dividing the interior space into an inner chamber and an outer chamber, and the inner wall has a first opening through which the inner chamber communicates with the outer chamber;
wherein the housing has an outer wall with the outer chamber between the inner wall and the outer wall, with a second opening in the outer wall;
a rechargeable desiccant disposed in the outer chamber;
a door disposed in the outer chamber and configured to be movable between a first position and a second position; wherein the door is configured to at least partially seal the second opening and unseal the first opening when in the first position, and at least partially seal the first opening and unseal the second opening when in the second position; and
an actuator operatively connected to the door and configured to move the door between the first position and the second position, wherein the actuator is formed from a shape memory alloy transitionable between a first state and a second state in response to a change in temperature of the shape memory alloy, and the shape memory alloy transitions between the first state and the second state to move the door from the first position to the second position.

2. The drying system of claim 1, wherein the actuator is configured as a wire that contracts in length in response to the change in temperature.

3. The drying system of claim 2, wherein:
a first end of the actuator is anchored to the housing and a second end of the actuator is anchored to the door; and
the door is pivotably secured to the housing and pivots about a pivot axis when the door moves from the first position to the second position.

4. The drying system of claim 1, further comprising a biasing spring biasing the door to the first position.

5. The drying system of claim 1, wherein:
when the shape memory alloy increases in temperature to a predetermined temperature, the shape memory alloy transitions from the first state to the second state; and
the rechargeable desiccant is disposed in sufficient proximity to the actuator such that heat from the actuator heats the rechargeable desiccant to remove moisture absorbed by the rechargeable desiccant.

6. The drying system of claim 5, further comprising:
a power source selectively connectable to the actuator to electrically energize the actuator, thereby heating the shape memory alloy such that the shape memory alloy transitions from the first state to the second state; and
an electronic controller operable to selectively connect the power source to the actuator.

7. The drying system of claim 1, further comprising:
a heating element disposed in the outer chamber and electrically energizable to heat the rechargeable desiccant sufficiently to remove moisture absorbed by the rechargeable desiccant;
wherein the actuator is disposed in sufficient proximity to the heating element such that the shape memory alloy is transitionable from the first state to the second state in response to heat from the heating element.

8. The drying system of claim 7, further comprising:
a power source selectively connectable to the heating element to electrically energize the heating element; and
an electronic controller operable to selectively connect the power source to the heating element.

9. The drying system of claim 1, further comprising:
a heating element disposed in the outer chamber and electrically energizable to heat the rechargeable desiccant sufficiently to remove moisture absorbed by the rechargeable desiccant;
a power source selectively connectable to the actuator to electrically energize the actuator, thereby heating the shape memory alloy such that the shape memory alloy transitions from the first state to the second state; wherein the power source is selectively connectable to the heating element separately from the actuator to electrically energize the heating element;
an electronic controller operable to selectively connect the power source to the actuator, and to separately selectively connect the power source to the heating element.

10. The drying system of claim 1, wherein the actuator is a first actuator, and the assembly further comprising:
a second actuator operatively connected to the door and configured to move the door between the second position and the first position, wherein the second actuator is formed from a shape memory alloy transitionable between a first state and a second state in response to a change in temperature of the shape memory alloy of the second actuator, and the shape memory alloy of the second actuator transitions between the first state and the second state to move the door from the second position to the first position; and
a bi-stable spring operatively connected to the door and biasing the door to the first position when the door is in the first position, and biasing the door to the second position when the door is in the second position.

11. The drying system of claim 1, further comprising:
a releasable latch configured to latch the door in the second position.

12. The drying system of claim 11, further comprising:
a power source selectively connectable to the actuator to electrically energize the actuator, thereby heating the actuator such that the shape memory alloy transitions from the first state to the second state; wherein the power source is disconnected from the actuator when the releasable latch holds the door in the second position.

13. The drying system of claim 12, wherein, when the power source is connected to the actuator to electrically energize the actuator when the door is held in the second position by the releasable latch, the releasable latch is configured to release the door.

14. The drying system of claim 12, wherein the actuator is a first actuator, and the assembly further comprising:
a second actuator operatively connected to the releasable latch, wherein the second actuator is formed from a shape memory alloy transitionable between a first state and a second state in response to a change in temperature of the shape memory alloy of the second actuator, and the shape memory alloy of the second actuator transitions between the first state and the second state to release the releasable latch from the door.

15. The drying system of claim 14, further comprising:
a heating element disposed in the outer chamber and electrically energizable to heat the rechargeable desiccant sufficiently to remove moisture absorbed by the rechargeable desiccant;
wherein the power source is selectively connectable to the second actuator to electrically energize the second actuator, thereby heating the second actuator such that the shape memory alloy of the second actuator transitions from the first state to the second state;
wherein the power source is selectively connectable to the heating element to electrically energize the heating element; and
an electronic controller operable to separately selectively connect the power source to the first actuator, to the second actuator, and to the heating element.

16. A lamp drying system comprising:
a lamp assembly including a housing and a lens mounted to the housing such that the housing and the lens define an interior space;
wherein the housing has an inner wall dividing the interior space into an inner chamber and an outer chamber, the lens mounted to the housing at the inner chamber, and the inner wall having a first opening through which the inner chamber communicates with the outer chamber;
a rechargeable desiccant disposed in the outer chamber;
a door disposed in the outer chamber and configured to be movable between a first position and a second position; wherein the door is configured to at least partially seal the second opening and unseal the first opening when in the first position, and at least partially seal the first opening and unseal the second opening when in the second position;
an actuator operatively connected to the door and configured to move the door between the first position and the second position, wherein the actuator is formed from a shape memory alloy transitionable between a first state and a second state in response to a change in temperature of the shape memory alloy, and the shape memory alloy transitions between the first state and the second state to move the door from the first position to the second position; and
wherein the rechargeable desiccant is disposed in sufficient proximity to the actuator such that electrical energizing of only one of the actuator or the rechargeable desiccant is sufficient to both cause the shape memory alloy to transition from the first state to the second state and remove moisture absorbed by the rechargeable desiccant.

17. The lamp drying system of claim 16, wherein, when the shape memory alloy increases in temperature to a predetermined temperature, the shape memory alloy transitions from the first state to the second state, the lamp drying system further comprising:
a power source selectively connectable to the actuator to electrically energize the actuator, thereby heating the actuator such that the shape memory alloy transitions from the first state to the second state; and
wherein the rechargeable desiccant is disposed in sufficient proximity to the actuator such that heat from the actuator heats the rechargeable desiccant to remove moisture absorbed by the rechargeable desiccant.

18. The lamp drying system of claim 16, wherein, when the shape memory alloy increases in temperature to a predetermined temperature, the shape memory alloy transitions from the first state to the second state, the lamp drying system further comprising:
a heating element disposed in the outer chamber and electrically energizable to heat the rechargeable desiccant sufficiently to remove moisture absorbed by the rechargeable desiccant;
a power source selectively connectable to the heating element to electrically energize the heating element; and
wherein the actuator is disposed in sufficient proximity to the heating element such that the shape memory alloy is transitionable from the first state to the second state in response to heat from the heating element.

19. The lamp drying system of claim 16, wherein the actuator is configured as a wire that contracts in length in response to the change in temperature;
a first end of the actuator is anchored to the housing and a second end of the actuator is anchored to the door; and
the door is pivotably secured to the housing and pivots about a pivot axis when the door moves from the first position to the second position.

20. The lamp drying system of claim 17, further comprising a biasing spring biasing the door to the first position.
